(19) United States
(12) Patent Application Publication
(10) Pub. No.: US 2007/0177000 A1
(43) Pub. Date: Aug. 2, 2007

(54) Laser beam isolation apparatus and image forming device having the same

(75) Inventor: Tae-kyoung Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/491,074

(22) Filed: Jul. 24, 2006

(30) Foreign Application Priority Data
Jan. 27, 2006 (KR) 2006-8842

(51) Int. Cl. G01D 15/14

(52) U.S. Cl. 347/230

(57) ABSTRACT

A laser beam isolation includes a blocking unit having an at least partially metallic shutter disposed in a laser scanning unit to be movable between a first position to open a path of a laser beam and a second position to block the path of the laser beam. A magnetic unit is disposed opposite to the shutter at least one of a cover and an image forming unit of the device to actuate the shutter to move to the first position when the cover is closed, or when the image forming unit is mounted in the device. During an opening of the cover or a removal of the image forming unit, the blocking portion is moved to the second position by its own weight or center of gravity and blocks a laser beam of a light source from being emitted out of the laser scanning unit.

### CROSS-REFERENCE TO RELATED APPLICATION

This application claims the benefit under 35 U.S.C. §119(a) of Korean Application No. 10-2006-8842, filed Jan. 27, 2006, in the Korean Intellectual Property Office, the disclosure of which is incorporated by reference.

### BACKGROUND OF THE INVENTION

1. Field of the Invention

Aspects of the present invention generally relate to an image forming device such as a laser printer. More particularly, Aspects of the present invention relate to a laser beam isolation apparatus which prevents a laser beam from being emitted out of a laser scanning unit (LSU) when the LSU erroneously operates in the absence of an image forming unit or in the opening of a cover due to abnormality of related parts, and an image forming device having the same.

2. Description of the Related Art

A general conventional printing apparatus such as a laser printer shown in FIG. 1, includes a paper feeding unit 1 in which paper sheets are stacked, and a paper conveying unit 2 to convey a paper sheet from the paper feeding unit 1. A laser scanning unit (LSU) 4 forms an electrostatic latent image on a photoconductor 3. An image forming unit 6 develops the electrostatic latent image on the photoconductor 3 into a visible image with a supply of toner thereon and then to form, with the supply of a transfer voltage between a transfer roller 5 and the photoconductor 3. A toner image on the paper sheet is conveyed by the paper conveying unit 2. A fusing unit 7 fixes the toner image on the paper sheet with heat and pressure. A paper discharging unit 8 discharges the paper sheet with the toner image fixed thereon.

Among the above parts of the printer, the LSU 4 functions to form an electrostatic latent image on the photoconductor 3 in accordance with an image signal by irradiating a laser beam 11 onto the photoconductor 3. The LSU 4 includes a laser diode 4a to emit the laser beam 11, a rotary polygon mirror 4b to deflect and reflect the laser beam 11 from the laser diode 4a at a constant linear velocity, a scan lens 4c to compensate for an error included in the laser beam 11 reflected from the rotary polygon mirror 4b, and a reflective mirror 4d to reflect the laser beam 11 towards a surface of the photoconductor 3. The laser beam 11 passes through a laser beam passing hole 4e in an LSU housing 4g.

Generally, the LSU 4 is provided above the image forming unit 6 and emits a laser beam 11 onto the surface of the photoconductor 3 via a beam passing hole 4f of the image forming unit 6. This construction causes undesirable exposure of the user to the laser beam 11 when he/she replaces an old image forming unit 6, or removes the image forming unit 6 to check a paper jam. In order to protect the user from a possible exposure to the laser beam, conventionally, the printer was provided with a laser beam isolation switch 10 as shown in FIGS. 2A and 2B, which cuts off the power supply of the laser diode 4a upon opening the cover 20 relative to the hinge axis 20a for repair, replacement, or the like.

The laser beam isolation switch 10 includes a switch 23 formed in a housing 14 and connected to the power supply (not shown) for the LSU 4, a switch operating member 60 formed in the housing 14 and operating the switch 23 in accordance with the opening and closing of the cover 20, and a projection 50 formed on the cover 20 and movable in association with the switch operating member 60 to operate the switch 23 by pressing the switch 23. The switch operating member 60 includes an operating portion 61 contacting the projection 50, a switch contacting portion 63 formed at a predetermined angle relative to the operating portion 61 to operate the switch 23 by contact, a hinge portion 62 arranged between the operating portion 61 and the contacting portion 63 to guide the rotational movement of the switch operating member 60, and a spring 64 disposed on the housing 14 to elastically pull the switch contacting portion 63.

Describing the operation of the conventional laser beam isolation switch 10 in detail, first, with the closing of the cover 20 as shown in FIG. 2A, the operating portion 61 of the switch operating member 60 is pressed downwards by the projection 50. Accordingly, the switch contacting portion 63 of the switch operating member 60 is rotated about the hinge portion 62 counterclockwise against the recovering force of the spring 64, thereby pressing the switch 23. As a result, the laser diode 4a is operated normally, and emits laser beam 11.

Next, with the opening of the cover 20 as shown in FIG. 2B, the projection 50 is spaced apart from the operating portion 61, followed by the switch contacting portion 63 rotated by the recovery force of the spring 64 about the hinge portion 62 clockwise to subsequently release the switch 23. As a result, operation of the laser diode is stopped, and the laser beam 11 is not released.

However, with the conventional laser beam isolation switch 10 as described above, the operation of the laser diode 4a is not stopped if the cover 20 is opened for the image forming unit replacement with the switch 23 not being operated due to an internal short circuit. As a result, the user can be exposed to the laser beam emitted from the LSU 4. Exposure to the LSU 4 can be dangerous especially if the laser beam 11 is directly emitted from the LSU 4 to parts of the body, such as an eye, when the user opens the cover 20 and removes the image forming unit 6.

In an attempt to solve the above problems, a laser printer having a laser beam isolation apparatus 51 as shown in FIGS. 3A and 3B, which covers a laser beam passing hole 4e′ of the LSU 4′ so as to block the laser beam 11′ that can be irradiated from the LSU 4′ during a removal of the image forming unit 6′. As shown in FIG. 3A, the laser beam isolation apparatus 51 of the laser printer includes a blocking plate 52 in a flattened U-shape movably secured to the axis 54 with one end and the other end to pivot to open and close the laser beam passing hole 4e′ formed at a lower side of the housing of the LSU 4′. An elastic spring 53 is disposed between the housing of the LSU 4 and the blocking plate 52 to elastically support the blocking plate 52 to the blocking position (see FIG. 3B) where the blocking plate 52 blocks the laser beam passing hole 4e′. An operation projection 55 maintains the blocking plate 52 at an opening position where the blocking plate 52 opens the laser beam passing hole 4e′ during a mounting of the image forming unit 6′.

With the image forming unit 6′ being mounted under the LSU 4′ as shown in FIG. 3A, the operation projection 55 of the image forming unit 6′ pushes the blocking plate 52 towards the opening position. Accordingly, the laser beam 11′ is emitted from the LSU 4′ onto the photoconductor 3′ through the laser beam passing hole 4e′ of the LSU 4′ and through the passing hole 4f′ of the image forming unit 6′.

Then, with the cover 20′ being opened and the image forming unit 6′ being removed from the LSU 4′ as shown in FIG. 3B, the blocking plate 52 is returned to the blocking position by the recovering force of the elastic spring 53. Accordingly, the blocking plate 52 is moved to close the laser beam passing hole 4e′ formed at a lower side of the LSU 4′ by the recovering force of the elastic spring 53. The laser beam 11′ from the LSU 4′ is reflected inwards of the housing of the LSU 4′ from the lower side 52′ of the blocking plate 52. Thus, the user is not exposed to the laser beam 11′.

While the conventional laser beam isolation apparatus 51 effectively blocks the laser beam 11′ of the laser diode (not shown) from being emitted outside of the LSU 4′ due to abnormality of the related parts during removal of the image forming unit 6′, the structure of the blocking plate 52 requires the employment of the elastic spring 53 to move the blocking plate 52 to the blocking position. As additional elastic springs 53 are required to move the blocking plate 52 to the blocking position, the structure of the laser beam isolation apparatus 51 becomes complex, and manufacture costs increase.

Further, in the conventional laser beam isolation apparatus 51, foreign substances such as dust sometimes enter into the interior of the LSU 4′ through the laser beam passing hole 4e′ with the movement of the blocking plate 52 to the blocking position, thus deteriorating the performance of the LSU 4′. In order to prevent entrance of foreign substances through the laser beam passing hole 4e′, the laser beam passing hole 4e′ may be sealed by a transparent glass. However, this has a drawback of high manufacturing cost due to employment of additional parts (i.e., the transparent glass).

### SUMMARY OF THE INVENTION

An aspect of the present invention is to provide a laser beam isolation apparatus where a blocking unit operable by a magnetic force of a magnet or an electromagnet installed at a cover and/or an image forming unit is disposed in a laser scanning unit (LSU), thereby simplifying a structure and reducing manufacturing costs, so that a laser beam from a light source is prevented from being emitted out of the LSU due to abnormal operation of the related parts during an opening of the cover and/or a removal of the image forming unit for repair, replacement or maintenance, and an image forming device having the same.

Another aspect of the present invention is to provide a laser beam isolation apparatus, which is capable of preventing foreign substances from entering into the LSU through a passing hole, and an image forming device having the same.

Additional aspects and advantages of the invention will be set forth in part in the description which follows and, in part, will be obvious from the description, or may be learned by practice of the invention.

In accordance with an aspect of the present invention, a laser beam isolation apparatus of an image forming device comprises a blocking unit having a shutter in which at least a portion is made of metal, the blocking unit being disposed in a laser scanning unit to be movable between a first position and a second position, the first position to open a path of a laser beam and the second position to block the path of the laser beam, and a magnetic unit disposed opposite to the shutter at least one of a cover and an image forming unit of the device to actuate the shutter to move to the first position at least one of a time when the cover is closed and a time when the image forming unit is mounted in the device.

In accordance with an aspect of the present invention, the shutter comprises a blocking member, the blocking member having a blocking surface part disposed vertically to the path of the laser beam downstream of a light source to irradiate the laser beam, and an actuating surface part disposed vertically to the blocking surface part.

In accordance with an aspect of the present invention, the blocking surface part comprises an opening formed at a position to pass the laser beam emitted from the light source therethrough when the blocking member is positioned in the first position.

In accordance with an aspect of the present invention, the blocking member is formed to be vertically movable or to rotate in a seesaw fashion between the first position and the second position.

In accordance with an aspect of the present invention, when the blocking member is formed to be vertically movable, the blocking unit further comprises a shutter guide to guide the blocking member to move between the first position and the second position.

In accordance with an aspect of the present invention, the shutter guide comprises a guide plate, the guide plate having at least one guide slot to vertically guide the blocking surface part, and a stopper surface to maintain the actuating surface part at the second position.

In accordance with an aspect of the present invention, when the blocking member is formed to rotate in a seesaw fashion, the blocking member further comprises a supporting axis installed at one of an upper portion of the blocking surface part and a connecter connecting between the blocking surface part and the actuating surface part.

In accordance with an aspect of the present invention, weights of the blocking surface part and the actuating surface part are set to have a center of gravity that the blocking member is maintained at the second position when there is no force applied thereon.

In accordance with an aspect of the present invention, the blocking unit further comprises a stopper to restrict a movement of the blocking member so as to prevent the actuating surface part from being maintained at a position beyond a magnetic range of the magnetic unit.

In accordance with an aspect of the present invention, the magnetic unit comprises a magnet or an electromagnet disposed opposite to the actuating surface part of the blocking member at the at least one of the cover and the image forming unit.

In accordance with another aspect of the present invention, an image forming device comprises a housing having a cover, an image forming unit installed in the housing, the image forming unit having a photoconductor on which a developer image is formed, a laser scanning unit installed in the housing, the laser scanning unit having a light source to irradiate a laser beam, and a passing hole through which the laser beam emitted from the light source passes toward the surface of the photoconductor, and a laser beam isolation unit to prevent the laser beam emitted from the light source from escaping from the laser scanning unit at least one of a time when the cover is opened and a time when the image forming unit is removed from the housing, wherein the laser beam isolation unit comprises a blocking unit having a shutter in which at least a portion is made of metal, the blocking unit being disposed in the laser scanning unit to be movable between a first position and a second position, the first position to open a path of the laser beam and the second position to block the path of the laser beam, and a magnetic unit disposed opposite to the shutter at least one of the cover and the image forming unit to actuate the shutter to move to the first position at least one of a time when the cover is closed and a time when the image forming unit is mounted in the housing.

In accordance with an aspect of the present invention, the shutter comprises a blocking member, the blocking member having a blocking surface part disposed vertically to the path of the laser beam downstream of the light source, and an actuating surface part disposed vertically to the blocking surface part.

In accordance with an aspect of the present invention, the blocking surface part comprises an opening formed at a position to pass the laser beam emitted from the light source therethrough when the blocking member is positioned in the first position.

In accordance with an aspect of the present invention, the blocking member is formed to be vertically movable or to rotate in a seesaw fashion between the first position and the second position.

In accordance with an aspect of the present invention, when the blocking member is formed to be vertically movable, the blocking unit further comprises a shutter guide to guide the blocking member to move between the first position and the second position.

In accordance with an aspect of the present invention, the shutter guide comprises a guide plate, the guide plate having at least one guide slot to vertically guide the blocking surface part, and a stopper surface to maintain the actuating surface part at the second position.

In accordance with an aspect of the present invention, when the blocking member is rotatable in a seesaw fashion, the blocking member further comprises a supporting axis installed at one of an upper portion of the blocking surface part and a connecter connecting between the blocking surface part and the actuating surface part.

In accordance with an aspect of the present invention, weights of the blocking surface part and the actuating surface part are set to have a center of gravity that the blocking member is maintained at the second position when there is no force applied thereon.

In accordance with an aspect of the present invention, the blocking unit further comprises a stopper to restrict a movement of the blocking member so as to prevent the actuating surface part from being maintained at a position beyond a magnetic range of the magnetic unit.

In accordance with an aspect of the present invention, the magnetic unit comprises one of a magnet and an electromagnet disposed opposite to the actuating surface part of the blocking member at the at least one of the cover and the image forming unit.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a conventional laser printer;

FIGS. 2A and 2B are partial sectional views illustrating an operation of a conventional laser beam isolation switch apparatus;

FIGS. 3A and 3B are partial sectional views illustrating an operation of a conventional laser beam isolation apparatus;

FIGS. 4A and 4B are partial sectional views illustrating a laser printer having a laser beam isolation unit in accordance with an exemplary embodiment of the present invention;

FIGS. 5A and 5B are partial sectional views taken along line I-I of FIG. 4A and line II-II of FIG. 4B, respectively;

FIG. 6 is a perspective view illustrating a blocking unit of the laser beam isolation unit of FIG. 4A according to an aspect of the invention;

FIGS. 7A and 7B are partial perspective views illustrating a modified example of the blocking unit of the laser beam isolation unit in accordance with the exemplary embodiment of the present invention; and

FIGS. 8A and 8B are partial perspective views illustrating another modified example of the blocking unit of the laser beam isolation unit in accordance with the exemplary embodiment of the present invention.

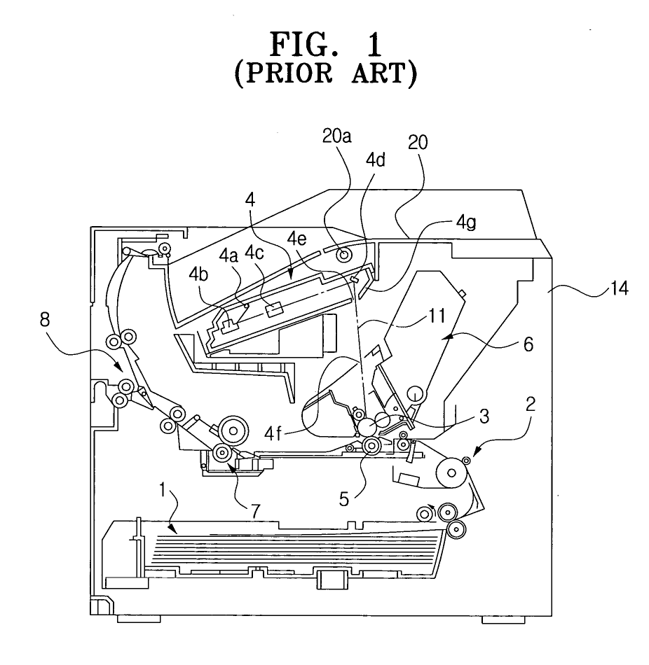

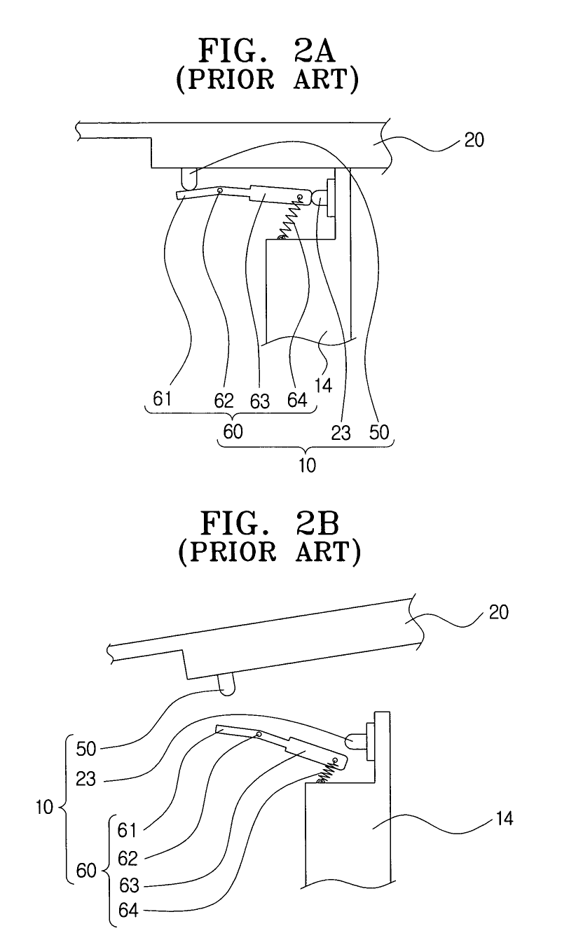

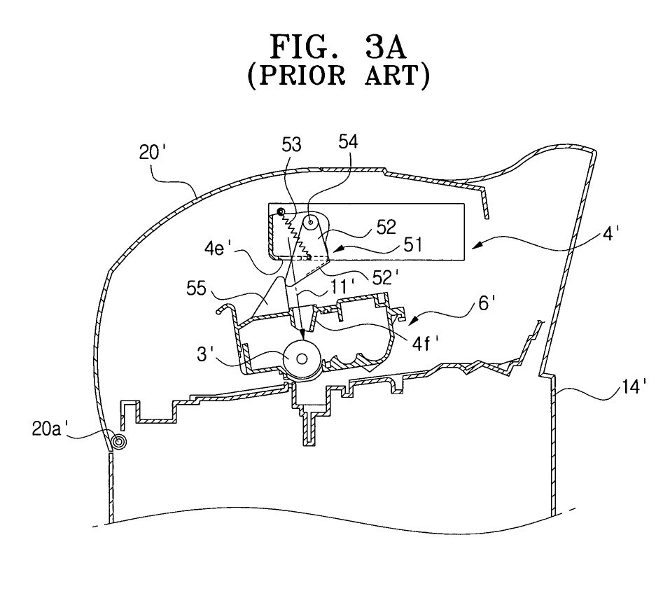

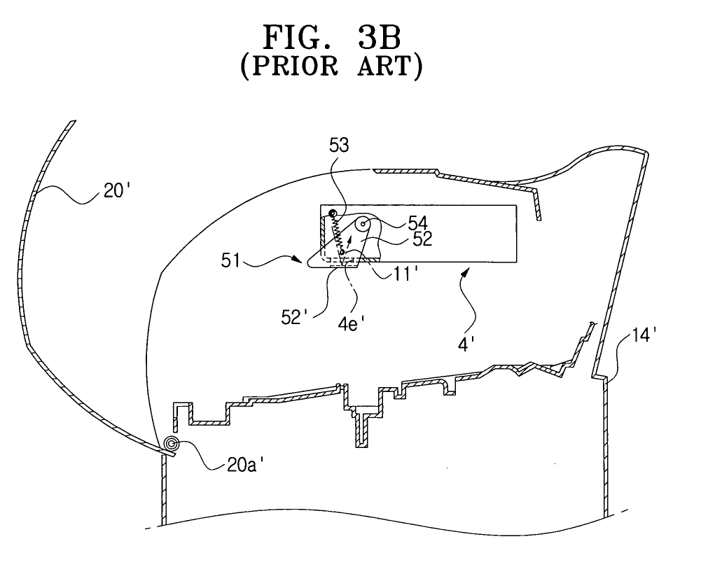

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness

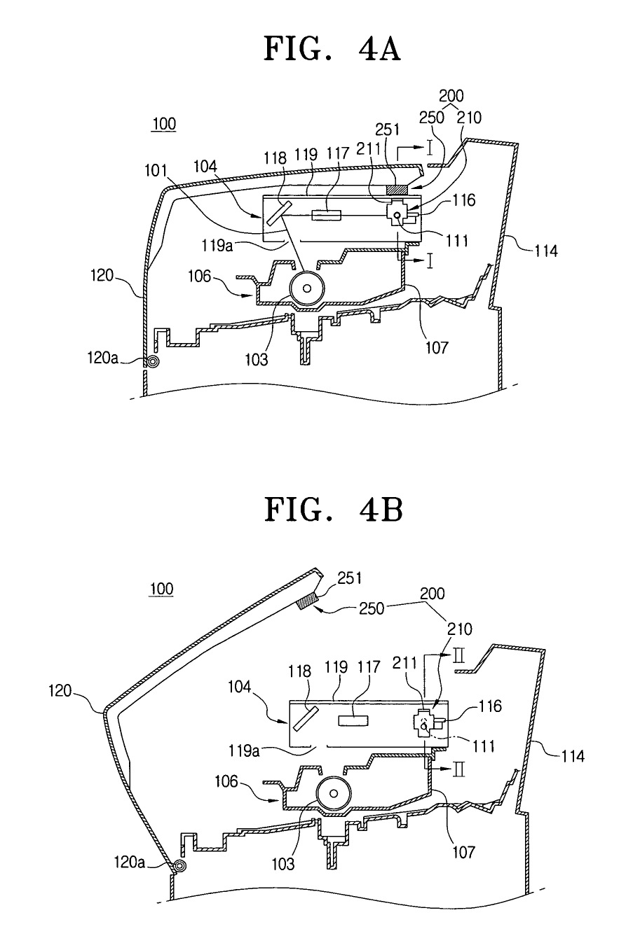

FIGS. 4A and 4B schematically illustrate an image forming apparatus having a laser beam isolation unit 200 in accordance with an exemplary embodiment of the present invention. The image forming apparatus having the laser beam isolation unit 200 in accordance with the exemplary embodiment of the present invention may be a laser printer 100 that prints and outputs data input from an external device, such as a computer. The present invention is not limited to the laser printer 100, however, and can include other image forming devices using a laser to impart images and multifunction devices which further provide copying, faxing and/or scanning.

As illustrated in FIG. 4A, the laser printer 100 includes a main body housing 114, an image forming unit 106, a laser scanning unit (LSU) 104, and a laser beam isolation unit 200. The main body housing 114 has a cover 120 movably secured to a hinge axis 120a so as to be pivoted thereon. The image forming unit 106 is detachably mounted under the LSU 104 in the main body housing 114 and includes a photoconductor 103 in the shape of drum on which a developer image is formed thereon. The LSU 104 is installed under the cover 120 to irradiate a laser beam 101 onto a surface of the photoconductor 103 and thus to form an electrostatic latent image thereon.

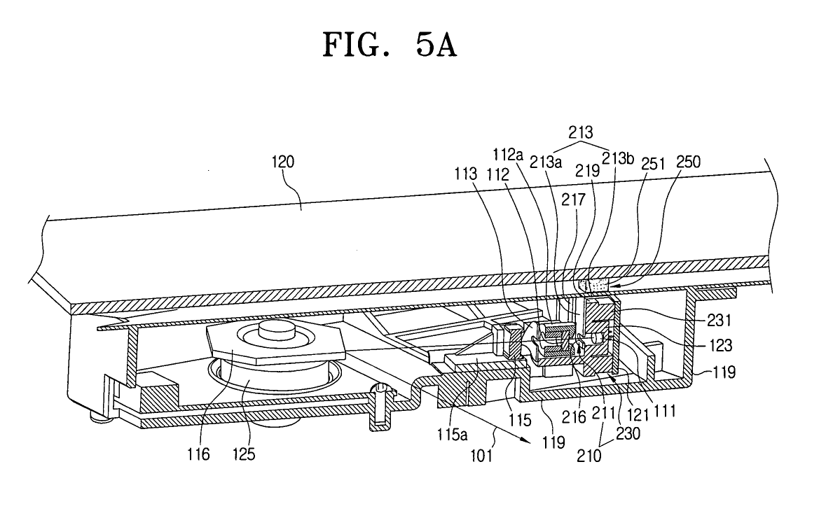

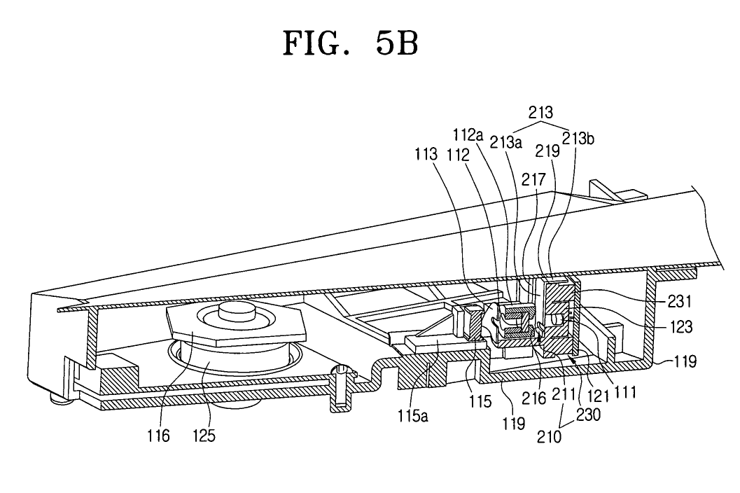

As illustrated in FIGS. 5A and 5B, the LSU 104 includes a light source 111, a collimator lens 112, a slit 113, a cylinder lens 115, a rotary polygon mirror 116, a scan lens 117, a reflective mirror 118, and an optical casing 119. The light source 111 is made up of a laser diode (not shown) to irradiate a laser beam 101, but can be other mechanisms for emitting lasers. The light source 111 is mounted on a circuit board 121 by a light source fixing bracket 123. The collimator lens 112 makes a laser beam 101 emitted from the light source 111 into a parallel light (i.e., collimates the beam). The collimator lens 112 is fixed on a guide plate 231 of a shutter guide 230 to be described below by a collimator lens fixing bracket 112a. The slit 113 blocks a peripheral portion of the laser beam 101, which has passed through the collimator lens 112, and thus standardizes the laser beam 101. The cylinder lens 115 makes the parallel light emitted from the collimator lens 112 into a linear light in a direction horizontal to a sub-scanning direction. The cylinder lens 115 is fixed on the optical casing 119 by a cylinder lens fixing bracket 115a. However, it is understood that the shown elements are by way of example and that not all shown elements are required in all aspects and/or that elements can be combined.

The rotary polygon mirror 116 deflects and reflects the linear light from the cylinder lens 115 at a constant linear velocity. For this, the rotary polygon mirror 116 has 6 divided reflective surfaces and an outer diameter of less than 40 mm. A scanning motor 125 is installed under the rotary polygon mirror 116 to rotate the rotary polygon mirror 116 at a constant speed. However, other sizes and numbers of surfaces can be used.

As shown in FIGS. 4A and 4B, the scan lens 117 refracts the laser beam 101 in the constant linear velocity deflected from the rotary polygon mirror 116 at a main-scanning direction. Also, the scan lens 117 compensates for the error included in the laser beam 101 reflected from the rotary polygon mirror 116 and then focuses the reflected beam 101 on the surface of the photoconductor 103 through the reflective mirror 118. The reflective mirror 118 reflects the laser beam 101 from the scan lens 117 in a certain direction and transmits onto the surface of the photoconductor 103. The optical casing 119 integrally contains respective components of the LSU 104, and is made of resin material. A laser beam passing hole 119a is formed at a lower portion of the optical casing 119 to allow the laser beam 101 reflected from the reflective mirror 118 to pass therethrough to reach the photoconductor 103.

The laser beam isolation unit 200 blocks a laser beam 101 of the light source 111 from being emitted out of the LSU 104 even when the light source 111 erroneously operates due to abnormality of a laser beam isolation switch (not shown) installed with respect to the cover 120 when the cover 120 is opened. The laser beam isolation unit 200 includes a blocking unit 210 and a magnetic unit 250.

The blocking unit 210 is disposed between the light source 111 and the collimator lens 112 in the optical casing 119. Here, it should be noted that although the blocking unit 210 is explained and illustrated as disposed between the light source 111 and the collimator lens 112, the unit 210 can be disposed at other proper position downstream of the light source 111. Examples of these other locations include, but are not limited to, between the collimator lens 112 and the slit 113, or between the slit 113 and the cylinder lens 115, or other locations at or between the laser beam passing hole 119a and the light source 111. Alternately, it is understood that the blocking unit 210 can be disposed outside of the LSU 104 at a location where, if the laser beam 101 is blocked, there is no risk of the user being affected by the laser beam 101. Additionally, it is understood that the blocking unit 210 could be integrated into existing elements of the LSU 104, such as the slit 113, or by including a blocking surface onto a mirror or lens that is actuated when the cover 120 is opened.

As illustrated in FIGS. 5A and 5B, the blocking unit 210 has a shutter 211 and a shutter guide 230 according to an aspect of the invention. The shutter 211 is disposed to be vertically movable between a first position (see FIGS. 4A and 5A) and a second position (see FIGS. 4B and 5B). The first position is a position to open a path of the laser beam 101, whereas the second position is a position to block the path of the laser beam 101.

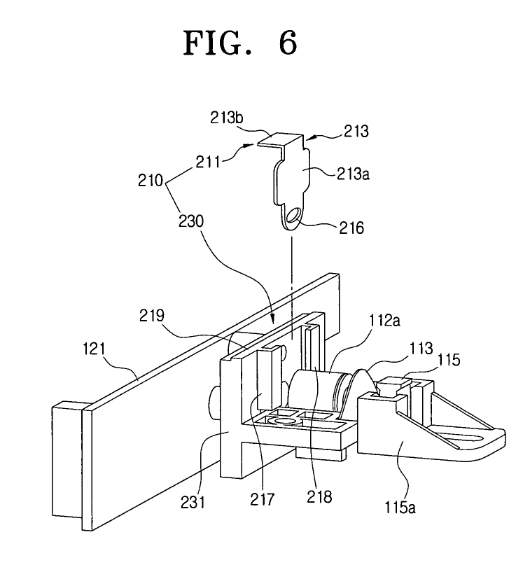

As illustrated in FIG. 6, the shutter 211 according to an aspect of the invention is formed of a L-shaped blocking member 213. The blocking member 213 has a blocking surface part 213a and an actuating surface part 213b. The blocking surface part 213a is disposed vertically to the path of the laser beam 101 downstream of the light source 111. The blocking surface part 213a has an opening 216 formed at a position to pass the laser beam 101 emitted from the light source 111 therethrough when the blocking member 213 is positioned in the first position (see FIGS. 4A and 5A). The blocking surface 213a can be a surface which absorbs the laser beam 101, traps the laser beam 101, dissipates/scatters the laser beam 101, redirects the laser beam 101, or otherwise renders the laser beam 101 harmless when the cover is opened.

The actuating surface part 213b is extended parallel to the path of the laser beam 101 and vertically to the blocking surface part 213a. However, it is understood that other shapes are possible, and that the opening 216 need not be a hole as shown but can be a slot or by the surface 213a being shortened such that when moved up, the laser beam 101 is not blocked, and when moved down, the laser beam 101 is blocked.

The shown blocking member 213 is made of a ferromagnetic body according to an aspect of the invention which is able to easily cling to a magnet or an electromagnet with a light magnetic force. Examples of the ferromagnetic body include, but are not limited to, a thin metal plate such as a thin iron or steel plate. Alternatively, the blocking member 213 can be configured, such that only the actuating surface part 213b, which is adhered to the magnetic unit 250 by the magnetic force thereof, is made of the ferromagnetic body. Thus, the surface part 213b can be constructed to interact magnetically with the magnetic unit 250.

The shutter guide 230 guides the shutter 211 between the first position and the second position. The shutter guide 230 is made up of a guide plate 231 having the light source fixing bracket 123 integrally formed therewith, as illustrated in FIGS. 5A, 5B and 6. However, it is understood that these elements can be non-integrally aligned in other aspects.

The shown guide plate 231 has first and second guide slots 217 and 218, and a stopping surface 219. The first and second guide slots 217 and 218 guide both side surface of the blocking surface part 213a of the blocking member 213 of the shutter 211 when the shutter 211 moves between the first position and the second position. The stopping surface 219 maintains the actuating surface part 213b of the blocking member 213 at the second position when the shutter 211 is moved to the second position. It is understood that the member 213 can have a slot 217 and 218 received in opposite edges on the plate 231.

As illustrated in FIGS. 4A and 5A, the magnetic unit 250 pulls the actuating surface part 213b of the blocking member 213 of the shutter 211 with a magnetic force to move the shutter 211 to the first position, when the cover 120 is closed. For this, the magnetic unit 250 is installed opposite the actuating surface part 213b of the blocking member 213 at an undersurface of the cover 120.

The magnetic unit 250 is made up of a permanent magnet 251 according to an aspect of the invention. Alternatively, the magnetic unit 250 can be made up of a general electromagnet in addition to or instead of the permanent magnet 251.

As described above, the laser beam isolation unit 200 in accordance with the exemplary embodiment of the present invention operates the shutter 211 of the blocking unit 210 with the magnetic force of the permanent magnet 251 installed at the cover 120 to move in combination therewith. Accordingly, the laser beam isolation unit 200 in accordance with the exemplary embodiment of the present invention does not have need of complex component such as the elastic spring to operate the shutter 211 as in the blocking plate 52 of the conventional laser beam isolation apparatus 51. As a result, manufacturing costs are reduced, while the structure of the LSU 104 is simplified. Also, since it is not necessary to operate the shutter 211 to the laser beam passing opening 119a to open and close the laser beam passing opening 119a as in the blocking plate 52 of the conventional laser beam isolation apparatus 51, entrance of foreign substances such as dust into the LSU 104 through the laser beam passing hole 119a is prevented.

The laser beam isolation operation of the laser printer 100 having the laser beam isolation apparatus 200 constructed as above according to the exemplary embodiment of the present invention will be described below with reference to FIGS. 4A through 6. First, as illustrated in FIGS. 4B and 5B, with the cover 120 of the laser printer 100 opened (such as for purposes such as repair, replacement or maintenance of the image forming unit 106), the permanent magnet 251 of the magnetic unit 250 moves along with the cover 120, and is separated from the actuating surface part 213b of the blocking member 213 of the shutter 211. As a result, the blocking member 213 is moved to a second position, which blocks a path of a laser beam 101, by its own weight with the blocking surface part 213a being guided along the first and the second guide slots 217 and 218, until the actuating surface part 213b is supported by the stopping surface 219.

Since the member 213 moves according to its own weight, it is understood that the member 213 can be angled as opposed to vertical as shown so long as the weight of the member 213 is sufficient to slide. Additionally, in addition to or instead of relying on gravity, another restoring force could be applied to the member 213, such as through a spring or another magnetic combination of surfaces, which moves the member 213 when the actuating surface part 213b is not magnetically connected to the magnetic unit 250. Further, while described as the member 213 being pulled toward the magnetic unit 250 to allow the laser beam 101 to pass, the magnetic unit 250 could instead repulse the member 213 against a biasing member to allow the laser beam 101 to pass, and when the magnetic unit 250 is removed, the member 213 moves to block the laser beam 101. As such, other arrangements can be used to allow the member 213 and the magnetic unit 250 to selectively interact to block the laser beam 101.

Accordingly, the laser beam 101 which may possibly be emitted from the light source 111 due to abnormal operation of the laser beam blocking switch when the cover 120 is opened, is not moved to the collimator lens 112, but is instead blocked due to the blocking surface part 213a of the blocking member 213. Then, the image forming unit 106 is removed, and repair, replacement or maintenance of the image forming unit 106 is carried out.

As illustrated in FIGS. 4A and 5A, with the image forming unit 106 being again mounted and the cover 120 of the laser printer 100 being closed after repair, replacement, or maintenance, the permanent magnet 251 of the magnetic unit 250 moves toward the shutter 211 along with the cover 120. As a result, the permanent magnet 251 pulls the actuating surface part 213b of the blocking member 213 with the magnetic force, so that the blocking member 213 is moved to a first position, which opens the path of the laser beam 101, with the blocking surface part 213a being guided along the first and the second guide slots 217 and 218. Accordingly, the laser beam 101, which is emitted from the light source 111, is irradiated on the surface of the photoconductor 103 through the collimator lens 112, the slit 113, the cylinder lens 115, the rotary polygon mirror 116, the scan lens 117, the reflective mirror 118 and the laser beam passing hole 119a. As a result, the operations for repair, replacement or maintenance of the image forming unit 106 are completed.

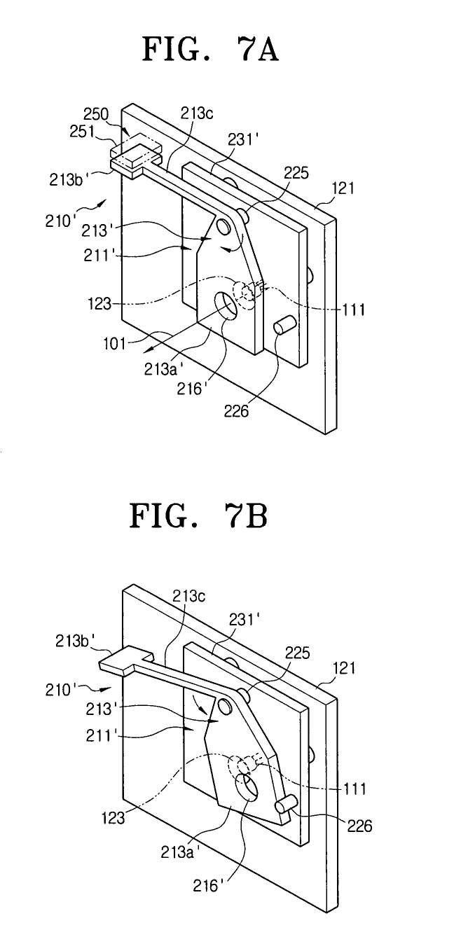

As previously noted, although the blocking unit 210 of the laser beam isolation unit 200 in accordance with the exemplary embodiment of the present invention has been explained and illustrated as made up of the shutter 211, and with the shutter guide 231 that guide to vertically move the shutter 211 between the first position and the second position, the invention is not limited thereto. For instance, as illustrated in FIGS. 7A and 7B, a blocking unit 210′ can be made up of a shutter 211′ formed to rotate in a seesaw fashion between the first position and the second position. In this way, the blocking unit 210′ utilizes a rocking motion instead of the sliding as shown in FIG. 6. However, it is understood that, while shown is rocking in a plane perpendicular to the optical path of the laser beam 101, the rocking motion can be about a non-perpendicular plane.

The shutter 211′ is formed of a L-shaped blocking member 213′ having a blocking surface part 213a′ and an actuating surface part 213b′. The blocking member 213′ is made of a ferromagnetic body, e.g., a thin metal plate such as a thin iron or steel plate, which is able to easily cling to a magnet or an electromagnet with a light magnetic force.

Like as the blocking surface part 213a explained with reference to FIG. 6, the blocking surface part 213a′ is disposed vertically to the path of the laser beam 101 downstream of the light source 111. The blocking surface part 213a′ has an opening 216′ formed at a position to pass the laser beam 101 emitted from the light source 111 therethrough when the blocking member 213′ is positioned in the first position (see FIG. 7A). The actuating surface part 213b′ is disposed above the blocking surface part 213a′. The blocking surface part 213a′ and the actuating surface part 213b′ are connected with each other by a connecter 213c. An upper portion of the blocking surface part 213a′ adjacent to the connecter 213c is rotatably supported at a supporting axis 225 formed on a supporting plate 231′. The supporting plate 231′ has the light source fixing bracket 123 integrally formed thereon to fix the light source 111 on the circuit board 121. While shown as above, it is understood that the part 213b′ can be below or otherwise located.

Weights of the blocking surface part 213a′ and the actuating surface part 213b′ are so set to have a center of gravity that the blocking member 213′ is maintained at a position illustrated in FIG. 7B. That is, the second position blocks the path of laser beam 101 when there is no force applied thereon. A stopper 226 is formed on the supporting plate 231′ to restrict a movement of the blocking surface part 213a′ of the blocking member 213′ so as to prevent the actuating surface part 213b′ from being maintained at a position beyond a magnetic range of the permanent magnet 251 of the magnetic unit 250. Accordingly, as illustrated in FIG. 7A, when the cover 120 is closed, the permanent magnet 251 of the magnetic unit 250 pulls the actuating surface part 213b′ of the blocking member 213′ with the magnetic force. As a result, the blocking member 213′ rotates about the supporting axis 225 in a clockwise direction and moves to the first position to open the path of the laser beam 101.

In contrast, as illustrated in FIG. 7B, when the cover 120 is opened, the permanent magnet 251 of the magnetic unit 250 is spaced out and separated from the actuating surface part 213b′ of the blocking member 213′. As a result, the blocking member 213′ rotates about the supporting axis 225 in a counterclockwise direction with its own center of gravity and returns to the second position to block the path of the laser beam 101.

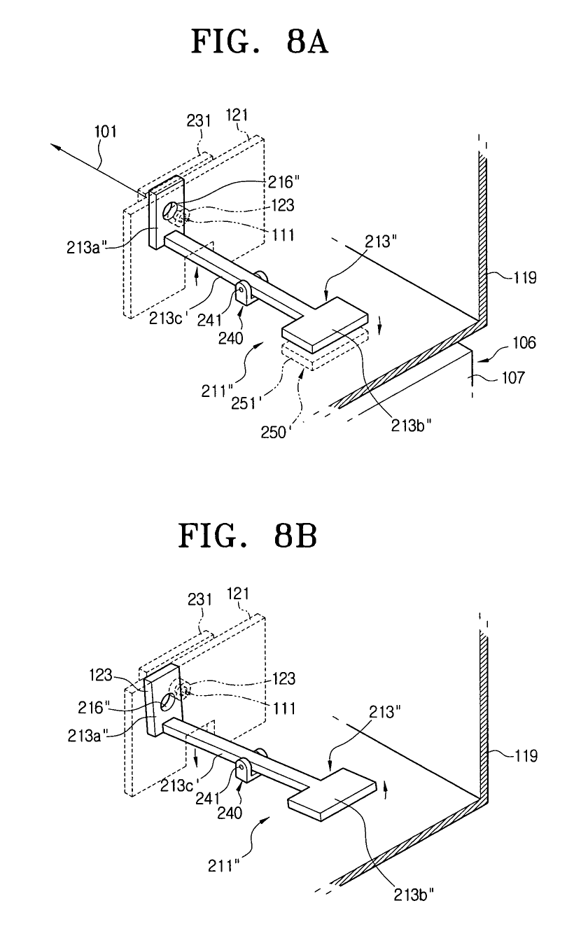

Also, although the laser beam isolation unit 200 in accordance with the exemplary embodiment of the present invention has been illustrated that the permanent magnet 251 of the magnetic unit 250 is installed at the cover 120, it is not limited thereto. For instance, as illustrated in FIG. 8A, a permanent magnet 251′ of a magnetic unit 250′ can be installed at an upper surface of a rear side of a developing casing 107 of the image forming unit 106. In this case, a shutter 211″ is formed of a L-shaped blocking member 213″ having a blocking surface part 213a″ and an actuating surface part 213b′. The blocking member 213″ is made of a ferromagnetic body (e.g., a thin metal plate such as a thin iron or steel plate) which is able to easily cling to a magnet or an electromagnet with a light magnetic force.

Like as the blocking surface part 213a of FIG. 6, or the blocking surface part 213a′ of FIGS. 7A and 7B, the blocking surface part 213a″ is disposed substantially vertically relative to the path of the laser beam 101 downstream of the light source 111. The blocking surface part 213a″ has an opening 216″ formed at a position to pass the laser beam 101 emitted from the light source 111 therethrough when the blocking member 213″ is positioned in the first position (see FIG. 8A).

The actuating surface part 213b″ is disposed substantially parallel to the path of the laser beam 101 and vertically to the blocking surface part 213a″. The blocking surface part 213a″ and the actuating surface part 213b″ are connected with each other by a connecter 213c′. A middle portion of the connecter 213c′ is rotatably supported by a supporting axis 241 formed at a supporting bracket 240 fixed to the optical casing 119.

Weights of the blocking surface part 213a″ and the actuating surface part 213b″ are so set to have a center of gravity that the blocking member 213″ is maintained at a position illustrated in FIG. 8B. That is, the second position blocks the path of laser beam 101 when there is no force applied thereon. Accordingly, as illustrated in FIG. 8A, when the image forming unit 106 is mounted in the main body housing 114, the permanent magnet 251′ of the magnetic unit 250′ pulls the actuating surface part 213b″ of the blocking member 213″ with the magnetic force. As a result, the blocking member 213″ rotates about the supporting axis 241 in a clockwise direction and moves to the first position to open the path of the laser beam 101.

In contrast, as illustrated in FIG. 8B, when the image forming unit 106 is removed from the main body housing 114, the permanent magnet 251′ is spaced out and separated from the actuating surface part 213b″ of the blocking member 213″. As a result, the blocking member 213″ rotates about the supporting axis 241 in a counterclockwise direction with its own center of gravity and returns to the second position to block the path of the laser beam 101.

As described above, with the laser beam isolation apparatus and the image forming device having the same according to the exemplary embodiment of the present invention, when opening the cover and/or removing the image forming unit, a laser beam from the light source is blocked by the blocking unit and thus prevented from being emitted to the outside even when the light source operates due to abnormal operation of the laser beam blocking switch. The blocking unit is operated in the LSU with the magnetic force of the magnetic unit installed at the cover and/or the image forming unit. Accordingly, the laser beam isolation apparatus and the image forming device having the same in accordance with the exemplary embodiment of the present invention do not have need of complex component such as the elastic spring to operate the blocking unit as in the blocking plate of the conventional laser beam isolation apparatus. As a result, complex assembling operations are not required and thus manufacturing costs are reduced, while the structure of the apparatus is simplified. Also, since it is not necessary to operate the shutter to the laser beam passing opening so as to open and close the laser beam passing opening as in the blocking plate of the conventional laser beam isolation apparatus, entrance of foreign substances such as dust into the LSU through the laser beam passing hole is prevented.

Although a few embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A laser beam isolation apparatus of an image forming device comprising:
a blocking unit having a shutter comprising a metal portion, the blocking unit being disposed in a laser scanning unit to be movable between a first position and a second position, the first position to open a path of a laser beam and the second position to block the path of the laser beam; and
a magnetic unit disposed opposite to the shutter and being on at least one of a cover and an image forming unit of the device to actuate the shutter using the metal portion to move to the first position at least one of a time when the cover is closed and a time when the image forming unit is mounted in the device.

2. The laser beam isolation apparatus of claim 1, wherein the shutter comprises an blocking member, comprising:
a blocking surface part disposed substantially perpendicular to the path of the laser beam emitted from a light source; and
an actuating surface part disposed substantially perpendicular to the blocking surface part.

3. The laser beam isolation apparatus of claim 2, wherein the blocking surface part comprises an opening formed at a position to allow the laser beam emitted from the light source to pass therethrough when the blocking member is in the first position.

4. The laser beam isolation apparatus of claim 2, wherein
the blocking member moves vertically between the first position and the second position, and
the blocking unit further comprises a shutter guide to guide the blocking member to move between the first position and the second position.

5. The laser beam isolation apparatus of claim 4, wherein the shutter guide comprises a guide plate comprising:
at least one guide slot to vertically guide the blocking surface part; and
a stopper surface to maintain the actuating surface part at the second position.

6. The laser beam isolation apparatus of claim 2, wherein
the blocking member rocks between the first position and the second position, and
the blocking member further comprises a supporting axis installed at one of an upper portion of the blocking surface part and a connecter connecting between the blocking surface part and the actuating surface part and about which the blocking member rocks.

7. The laser beam isolation apparatus of claim 6, wherein blocking surface part and the actuating surface part are weighted to have a center of gravity that the blocking member stays at the second position when there is no force applied thereon.

8. The laser beam isolation apparatus of claim 6, wherein the blocking unit further comprises a stopper to restrict a movement of the blocking member so as to prevent the actuating surface part from being at a position beyond a magnetic range of the magnetic unit.

9. The laser beam isolation apparatus of claim 2, wherein the magnetic unit comprises one of a magnet and an electromagnet disposed opposite to the actuating surface part of the blocking member at the at least one of the cover and the image forming unit.

10. An image forming device comprising:
a housing having a cover;
an image forming unit installed in the housing and having
a photoconductor on which a developer image is formed;
a laser scanning unit installed in the housing and having a light source to irradiate a laser beam, and a passing hole through which the laser beam emitted from the light source passes toward a surface of the photoconductor; and
a laser beam isolation unit to prevent the laser beam emitted from the light source from escaping from the laser scanning unit when the cover is opened and/or when the image forming unit is removed from the housing;
wherein the laser beam isolation unit comprises:
a blocking unit having a shutter having a metallic portion,
the blocking unit being disposed in the laser scanning unit to be movable between a first position and a second position, the first position to open a path of the laser beam and the second position to block the path of the laser beam; and
a magnetic unit disposed opposite to the shutter at at least one of the cover and the image forming unit and which uses the metal portion to actuate the shutter to move to the first position at least one of a time when the cover is closed and/or when the image forming unit is mounted in the housing.

11. The image forming device of claim 10, wherein the shutter comprises a blocking member comprising:
a blocking surface part disposed substantially perpendicular to a path of the laser beam; and
an actuating surface part disposed substantially perpendicular to the blocking surface part.

12. The image forming device of claim 11, wherein the blocking surface part comprises an opening formed at a position to allow the laser beam emitted from the light source to pass therethrough when the blocking member is positioned in the first position.

13. The image forming device of claim 11, wherein
the blocking member is vertically movable between the first position and the second position, and
the blocking unit further comprises a shutter guide to guide the blocking member to move between the first position and the second position.

14. The image forming device of claim 13, wherein the shutter guide comprises a guide plate comprising:
at least one guide slot to vertically guide the blocking surface part; and
a stopper surface to maintain the actuating surface part at the second position.

15. The image forming device of claim 11, wherein
the blocking member rocks between the first position and the second position, and
the blocking member further comprises a supporting axis installed at one of an upper portion of the blocking surface part and a connecter connecting between the blocking surface part and the actuating surface part and about which the blocking member rocks.

16. The image forming device of claim 15, wherein the blocking surface part and the actuating surface part are weighted to have a center of gravity such that the blocking member stays at the second position when there is no force applied thereon.

17. The image forming device of claim 15, wherein the blocking unit further comprises a stopper to restrict a movement of the blocking member so as to prevent the actuating surface part from being maintained at a position beyond a magnetic range of the magnetic unit.

18. The image forming device of claim 11, wherein the magnetic unit comprises one of a magnet and an electromagnet disposed opposite to the actuating surface part of the blocking member on at the at least one of the cover and the image forming unit.

19. An image forming apparatus comprising:
a housing having a cover;
a scanning unit disposed in the housing to emit a laser, including a blocking part to selectively block the laser; and
an image forming unit disposed in the housing to develop an image from the emitted laser and which is removable from the housing,
wherein:
at least one of the cover and the image forming unit has a magnet or an electromagnet, and
wherein the blocking portion moves to a position to open a path of the laser by a magnetic force of the magnet or the electromagnet when the cover is closed or when the image forming unit is installed in the housing.

20. A beam isolation apparatus for use in blocking an emitting beam, the apparatus comprising:
a housing including a cover, wherein the cover is detachable from the housing to access an interior of the housing;
a light emitting device disposed in the housing and emitting a light beam to be received at a surface along an optical path;
a blocking unit having a light blocking element and a first attractive unit disposed along the optical path, the blocking unit being movable between a first position which blocks the light beam and a second position which does not block the path; and
a biasing unit disposed on the cover to interact with the first attractive unit to selectively bias the blocking unit according to movement of the cover, wherein the biasing unit biases the first attractive portion to move the light blocking element to the first position when the cover is moved to allow access to the interior and to the second position when the cover prevent access to the interior.

21. The beam isolation apparatus of claim 20, wherein the biasing unit comprises a second attractive unit which biases the first attractive unit without contacting the first attractive unit according to a force.

22. The beam isolation apparatus of claim 21, wherein the force comprises a magnetic force which attracts and/or repels the first attractive unit relative to the second attractive unit.

23. The beam isolation apparatus of claim 20, wherein:
the blocking unit comprises a track which slideably connects the light blocking element to move between the first and second positions; and
the biasing unit pulls the first attractive unit to slide the light blocking element along the tracks to the first position when the cover is moved to allow access to the interior and to slide the light blocking element along the tracks to the second position when the cover prevent access to the interior.

24. The beam isolation apparatus of claim 20, wherein:
the blocking unit comprises a pivot about which the light blocking element rotates between the first and second positions; and
the biasing unit pulls the first attractive unit to rotate the light blocking element about the pivot to the first position when the cover is moved to allow access to the interior and to rotate the light blocking element about the pivot to the second position when the cover prevent access to the interior.

25. The beam isolation apparatus of claim 20, wherein the surface is a photoconductor used to impart an image on a medium.
